(19) United States
(12) Patent Application Publication
(10) Pub. No.: US 2016/0259437 A1
(43) Pub. Date: Sep. 8, 2016

(54) OPTICAL TOUCH SENSOR

(71) Applicant: Peigen Jiang, Sammamish, WA (US)

(72) Inventor: Peigen Jiang, Sammamish, WA (US)

(21) Appl. No.: 14/641,373

(22) Filed: Mar. 7, 2015

(51) Int. Cl. G06F 3/0354; G06F 3/038; G06F 3/02

(52) U.S. Cl. CPC G06F 3/03547; G06F 3/0213; G06F 3/038

(57) ABSTRACT

An optical touch sensor is disclosed which comprises a light emitting die placed at a first edge bordering an object surface, a light detecting die placed at a second edge bordering the object surface across from the first edge, a first reflective surface directing light emitted from the light emitting die toward the light detecting die, and a second reflective surface directing light emitted from the light emitting die onto the light detecting die, wherein a light beam traveling from the first reflective surface to the second reflective surface is above and substantially parallel to the object surface.

### BACKGROUND

The present invention relates generally to touch sensor, and, more particularly, to an optical touch sensor for computer input devices.

A popular way to position a cursor on a computer display is to use a mouse, which functions by detecting two dimensional motions relative to its supporting surface. Physically, a mouse comprises an object held under one of a user's hands, with one or more buttons. Clicking or hovering (stopping movement while the cursor is within the bounds of an area) can select files, programs or actions from a list of names, or (in graphical interfaces) through small images called “icons” and other elements. For example, a text file might be represented by a picture of a paper notebook, and clicking while the cursor hovers over this icon might cause a text editing program to open the file in a window.

A conventional keyboard can detect a pressing of any key thereof, but cannot detect mere touches on the keys. Here, the “touch” refers to a surface of the keyboard being contacted by an object regardless if the key is pressed or not. If the conventional keyboard is a tactile one, the key pressing results from the key being depressed. If the conventional keyboard is a surface one, such as Touch Cover for Microsoft Surface, the key pressing results from a force being applied on the key. As long as the key remains depressed in tactile keyboard or forced upon in surface keyboard, the key is pressed.

There are significant interests in incorporating mouse functions into a keyboard. One way to do it is to provide a touch tensor to a keyboard to form a combo device that detects touches on a surface of the keyboard, and switching operations of the combo device between a cursor mode and a keyboard mode as programmed. Conventionally the touch sensor employs arrays of light-emitting diodes (LED) to scan the surface of the keyboard with infrared (IR) light. When the scanning light is blocked, a surface touching object is then detected at the blocking location. However, touch sensors employing conventionally packaged LEDs are quite bulky and less accurate.

As such, what is desired is a touch sensor that can accurately detect touch location and are less protrusive.

### BRIEF DESCRIPTION OF THE DRAWING

FIG. 1 is a perspective view of a laptop computer with a keyboard.

FIG. 2 illustrates an infrared-light touch sensing system positioned to detect touch on the keyboard surface.

FIG. 3 illustrates a LED-based touch coordinate detection system.

FIG. 4 illustrates an array of LEDs packaged in the same substrate according to an embodiment of the present invention.

FIG. 5 is a cross-sectional view of a LED package according to an embodiment of present invention.

FIG. 6 is a cross-sectional view of a keyboard with touch sensing using the LED package of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to an optical touch sensor designed, particularly, for keyboard-and-mouse combo devices to provide cursor input for computers. A preferred embodiment of the present invention will be described hereinafter with reference to the attached drawings.

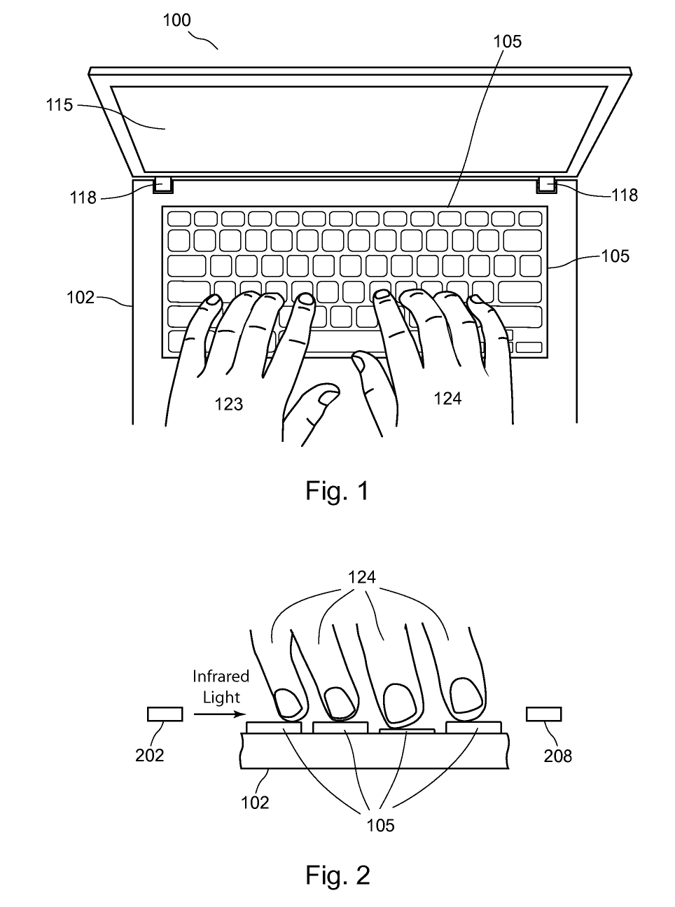

FIG. 1 is a perspective view of a laptop computer 100 with a conventional keyboard 105 for entering text, etc. The laptop computer 100 has a base unit 102 containing the keyboard 105, and a display panel 115 which is hinged to the base unit 102 by hinges 118. A skilled computer user can generally type on the keyboard 105 with both hands 123 and 124. An optical touch sensor can detects whether or not the surface of the keyboard 105 is touched without interfering with regular keyboard operations.

FIG. 2 illustrates an infrared-light touch sensing system positioned to detect touches on the surface of the keyboard 105. The infrared-light touch sensing system includes an infrared light emitter 202 and an infrared light receiver 208. The infrared light travels across the surface of the keyboard 105. A finger 124 or any other object touching the surface of the keyboard 105 blocks the infrared light from being received by the infrared light receiver 208. As a result, the touch can be detected.

Referring back to FIG. 1, the infrared light emitter 202 can be positioned along one edge of the keyboard 105 and the infrared light receiver 208 can be positioned along the opposite edge of the keyboard 105. In order to obtain coordinates of a touch, two sets of the infrared light touch sensors will be needed with one set positioned on the horizontal edges and the other on the vertical edges.

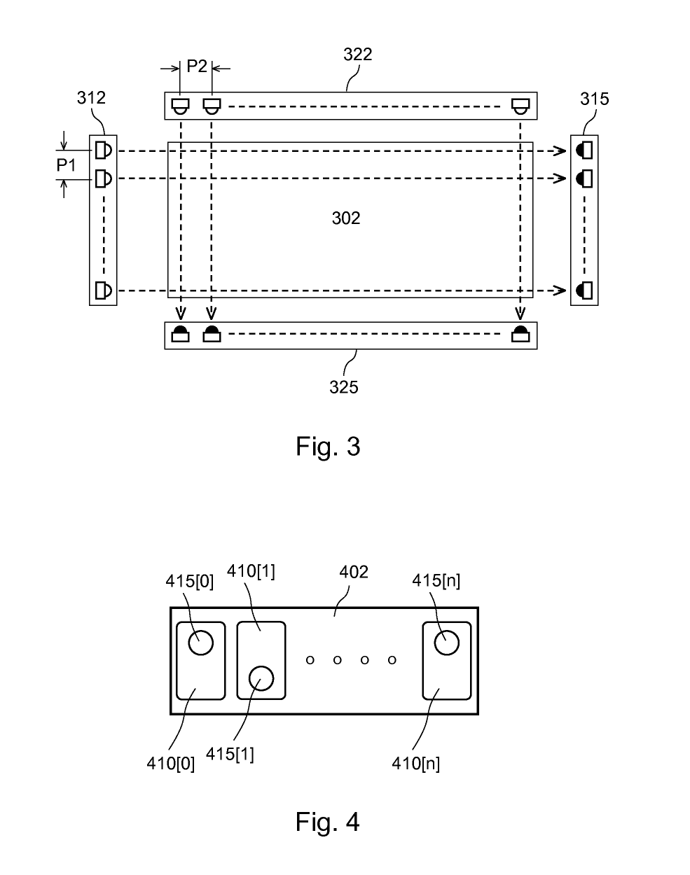

FIG. 3 illustrates a LED-based touch coordinate detection system which comprises a pair of horizontally placed LED arrays 312 and 315 and a pair of vertically placed LED arrays 322 and 325. The LED arrays 312 and 322 controllably emit light, and the LED arrays 315 and 325 correspondingly detects light. If light is blocked at certain detecting LEDs, then coordinates of the blocking object can be extracted from the corresponding LED locations. Pitches P1 and P2 between two adjacent LEDs determine accuracy of the LED touch coordinate detection system, i.e., the smaller the pitches P1 and P2, the more accurate the touch coordinate detection system is.

Conventionally LED dies are individually packaged and then mounted into an array as shown in FIG. 3. Even though individual LED die size can be very small, individually packaged LED is large due to the packaging material. Reduction of the pitches P1 and P2 using conventionally packaged LEDs is limited.

FIG. 4 illustrates an array of LED dies 410[0:n] packaged in the same substrate 402 according to an embodiment of the present invention, where n is an integer. Each die 410[i] has an anode 415[i] on the top and a cathode on the bottom (not shown), where i is an integer between 0 and n. Wire bonding may be used to connect each anode 415 to an external lead (not shown). In order to separate leads more widely, leads of adjacent LED dies 410[0] and 410[1] may be placed on opposite sides of the substrate 402. For instance, if the lead for anode 415[0] is placed on the upper side of the substrate 402, the lead for anode 415[1] is placed on the lower side of the substrate 402 as shown in FIG. 4. The cathodes of all the LED dies 410[0:n] can be commonly connected to a single external lead (not shown). Because the LED dies 410[0:n] are bare dies, pitch between juxtaposing units is mostly limited by the size of the LED dies 410[0:n] themselves. Therefore, a LED array formed in this way can have very fine pitches.

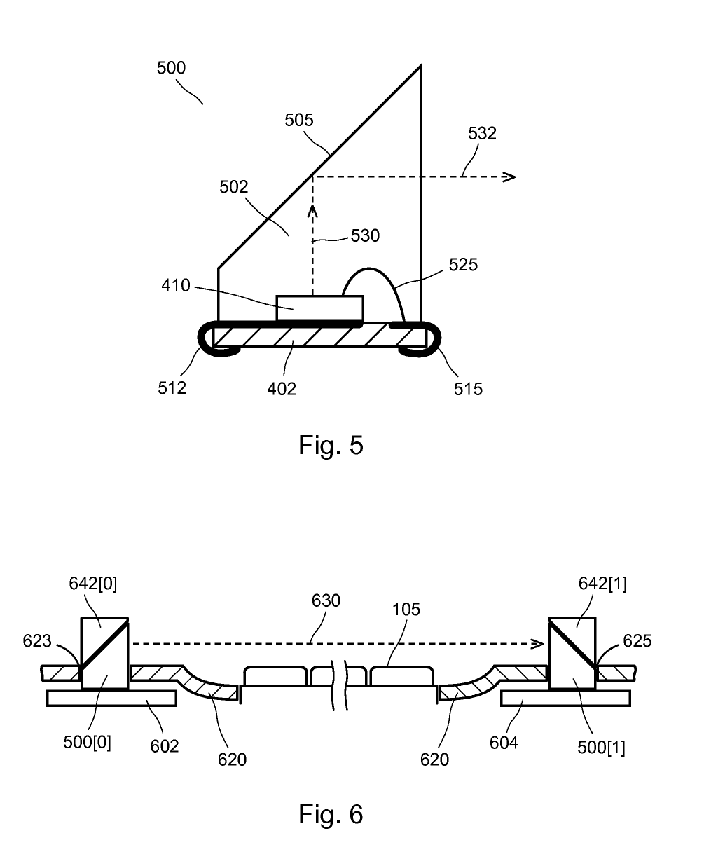

FIG. 5 is a cross-sectional view of a LED package 500 according to an embodiment of present invention. The LED package 500 comprises a LED die 410 horizontally mounted on the surface of a substrate 402, leads 512 and 515, and a plastic shell 502. The lead 512 is connected to a cathode of the LED die 410 at the bottom thereof. The lead 515 is wire bonded an anode of the LED die 410 on the top thereof. The plastic shell 502 is made of a material transparent to infrared, and has a slanted flat surface 505 on the top which is coated with a reflective material for reflecting light emitted from the LED die 410. As shown in FIG. 5, the LED die 410 emits light 530 upwardly and, the slanted flat surface 505 redirects the light 532 to a horizontal direction. In embodiments, the slanted flat surface 505 is angled at 45 degrees to the horizontal surface, so that majority of the reflected light 530 travel in parallel to the horizontal surface. In embodiments, an entire length of a LED array is covered by one piece of the plastic shell 502 which is molded into a desired shape.

Although FIG. 5 shows a light emitting LED package 500, a skilled artisan would recognize that a light detecting LED package can have the same structure as that of the light emitting LED package 500. In some applications, light emitting LED and light detecting LED can be interchangeably used.

FIG. 6 is a cross-sectional view of a keyboard with touch sensing using the LED package 500 shown in FIG. 5. A light emitting LED package 500[0] is mounted on a printed circuit board 602 with a top portion protruding through an opening 623 on a keyboard enclosure 620. A light detecting LED package 500[1] is mounted on another printed circuit board 604 with a top portion protruding through an opening 625 on the other side of the keyboard enclosure 620. Light beam 630 traveling from the LED package 500[0] to the LED package 500[1] is slightly above and substantially parallel to a surface of the keyboard 620.

Referring again to FIG. 6, in order to protect the reflective surface of the LED package 500, an added member 642[0] is attached to a top part of the LED package 500[0], and an added member 642[1] is attached to a top part of the LED package 500[1]. The added members 642 and 644 also ornament the protruding LED packages 500[0:1]. In embodiments, the added members 642[0:1] are molded plastic covering only the slanted reflective surface of the LED packages 500[0:1], respectively, and are conveniently made symmetrical. In other embodiments, the added member 642 is made of a dark material, when being attached to the slanted surface of the LED package 500, the slanted surface becomes reflective.

While this disclosure has been particularly shown and described with references to exemplary embodiments thereof, it shall be understood by those skilled in the art that various changes in form and details may be made therein without departing from the spirit of the claimed embodiments.

What is claimed is:

1. An optical touch sensor comprising:
a first light emitting die placed at a first edge bordering an object surface;
a first light detecting die placed at a second edge bordering the object surface across from the first edge;
a first reflective surface directing light emitted from the first light emitting die toward the first light detecting die; and
a second reflective surface directing light emitted from the first light emitting die onto the first light detecting die,
wherein a light beam traveling from the first reflective surface to the second reflective surface is above and substantially parallel to the object surface.

2. The optical touch sensor of claim 1, wherein the first light emitting die emits light in a direction substantially perpendicular to the object surface.

3. The optical touch sensor of claim 1, wherein the first reflective surface is angled at approximately 45 degrees to a surface of the first light emitting die.

4. The optical touch sensor of claim 1, wherein the second reflective surface is angled at approximately 45 degrees to a surface of the first light detecting die.

5. The optical touch sensor of claim 1, wherein the first reflective surface belongs to a slanted wall of a transparent shell that encloses the first light emitting die.

6. The optical touch sensor of claim 5, wherein the transparent shell protrudes from a top surface of the first edge.

7. The optical touch sensor of claim 6 further comprising a member attached to the slanted wall for protecting and decorating the transparent shell.

8. The optical touch sensor of claim 1, wherein the second reflective surface belongs to a slanted wall of a transparent shell that encloses the first light detecting die.

9. The optical touch sensor of claim 8, wherein the transparent shell protrudes from a top surface of the second edge.

10. The optical touch sensor of claim 9 further comprising a member attached to the slanted wall for protecting and decorating the transparent shell.

11. The optical touch sensor of claim 1, wherein the object surface is a surface of a keyboard.

12. The optical touch sensor of claim 1 further comprising a second light emitting die mounted juxtaposing the first light emitting die, the first and the second light emitting dies are mounted on the same substrate and enclosed by the same shell.

13. The optical touch sensor of claim 12, wherein the first and the second light emitting dies are light emitting diodes (LED).

14. The optical touch sensor of claim 12, wherein a terminal of the first light emitting die is wire bonded to a first lead on a first side of the substrate, and a terminal of the second light emitting die is wire bonded to a second lead on a second side of the substrate, wherein the first side is opposite to the second side.

15. The optical touch sensor of claim 14, wherein the substrate along with the shell is mounted to a printed circuit board with the first and second leads.

16. The optical touch sensor of claim 1 further comprising a second light detecting die mounted juxtaposing the first light detecting die, the first and the second light detecting dies are mounted on the same substrate and enclosed by the same shell.

17. The optical touch sensor of claim 16, wherein the first and the second light detecting dies are light emitting diodes (LED).

18. The optical touch sensor of claim 16, wherein a terminal of the first light detecting die is wire bonded to a first lead on a first side of the substrate, and a terminal of the second light detecting die is wire bonded to a second lead on a second side of the substrate, wherein the first side is opposite to the second side.

19. The optical touch sensor of claim 18, wherein the substrate along with the shell is mounted to a printed circuit board with the first and second leads.

20. An optical touch sensor comprising:
an object having a surface area bordered by a first edge and a second edge opposite to each other across the surface area;
an array of light emitting dies mounted on the same first substrate and enclosed by the same first shell, the first substrate being mounted on a first printed circuit board located at the first edge;
an array of light detecting dies mounted on the same second substrate and enclosed by the same second shell, the second substrate being mounted on a second printed circuit board located at the second edge;
a first reflective surface directing light emitted from the array of light emitting dies toward the array of light detecting dies; and
a second reflective surface directing light emitting from the array of light emitting dies onto the array of light detecting dies,
wherein light beams traveling from the first reflective surface to the second reflective surface are above and substantially parallel to the surface area.
